(19) United States
(12) Patent Application Publication
(10) Pub. No.: US 2005/0166996 A1
(43) Pub. Date: Aug. 4, 2005

(54) Type of carbide tip for tree stump grinding and cutting tooth

(76) Inventor: Guofang Cao, Diamond Bar, CA (US)

Correspondence Address: LAW OFFICES OF J.F. LEE, 17800 CASTLETON STREET, SUITE 383, CITY OF INDUSTRY, CA, 91748, US

(21) Appl. No.: 10/767,049

(22) Filed: Jan. 29, 2004

(51) Int. Cl. B27M 3/00; A01G 23/06; B27C 1/00; B27C 5/00; B27G 13/00

(52) U.S. Cl. 144/24.12; 144/176

(57) ABSTRACT

A new kind of carbide tip for tree stump cutting, where the surface of the carbide tip is serrated, having multiple grooves in different geometric arrangements. The presence of the serration effectively reduces resistance when the carbide tip is used to cut into tree stump and enhances heat dissipation due to increased surface area that contributes to better metallurgical stability of the carbide tip.

### FIELD AND BACKGROUND OF THE INVENTION

The present invention relates generally to design and construction of carbide tip used on machines for tree stump cutting and grinding.

Modern tree stump cutting and grinding machines in general have a rotary disc driven by motor; the disc has multiple teeth attached at the outer edge of the disc so that when the disc is spinning/rotating, the teeth on the edge repeatedly cuts towards the tree stump, or any work piece. These prior art structures are disclosed in several U.S. Patents, such as U.S. Pat. Nos. 3,937,261, 3,935,877, and 4,795,394, etc.

In all the prior art teeth structures, and in use today, the cutting tooth is formed by a steel shank, upon which a carbide tip is mounted on to serve as the cutting blade. In most cases, the carbide tip is made of tungsten and cobalt alloy. And the surface of the carbide tip is invariably flat.

Repeated use of the carbide tip usually result in damage to said carbide tip due to the unavoidable hard impact on the carbide tip and the resulting heat associated with the cutting. Cutting into hard stones or metallic substances is only natural because tree stump cutting is always near the ground level.

Some prior art patents teach about tilting the angle of the flat-surfaced carbide tip when attaching to the tooth on the cutting disc. Although such a tilted angle reduces the brute impact force on the carbide tip, it creates a lateral tension on the cutting disc, and therefore on the axle, when the cutting disc is at work. This is just like the helicopter propellers generating a lateral force (downward). Such a tilted-angled carbide tip forces the arrangement of the teeth on the cutting disc to go in mirroring pairs or in tandem pairs of left/right tilts.

### OBJECTS AND SUMMARY OF THE INVENTION

Present invention provides an improved design and construction of the carbide tip, by adding serration on the surface of the carbide tip. At time of cutting tree stump, the serrated feature reduces the resistance from the tree stump, even when cutting through rocks and metals.

The serration also dramatically increases the surface area of the carbide tip that comes in contact with the air when working, resulting in better heat dissipation and help to prolong the metallurgical stability of the carbide tip.

Present invention will further allow the design of tree stump cutting disc to have greater freedom in arrangement of the teeth.

### DESCRIPTION OF THE DRAWINGS

The accompanying drawings, which are incorporated in and constitute a part of this specification, illustrate the preferred embodiment of the invention and together with the description, serve to explain the principles of the invention.

A brief description of the drawings is as follows:

FIGS. 1a, 1b and 1c show the typical way of carbide tip fixed to the shank of a tooth on a tree stump cutting disc.

FIG. 1a is an enlarged view of a carbide tip on a shank portion of a tooth. The side on top is the side where serration will be added, as claimed in present application.

FIG. 1b shows the perspective view of a carbide tip attached to the shank portion of a cutting tooth.

FIG. 1c shows the side view of a carbide tip attached to the shank portion of a cutting tooth.

FIG. 2a shows one embodiment of present invention, where the serration on the surface used to cut the tree stump is made up of parallel grooves.

FIG. 2b shows the same parallel grooves as in 2a, except the serration top is rounded off; reference FIGS. 4a and 4b.

FIG. 2c shows another embodiment of present invention, where left parallel grooves and right parallel grooves mirror each other from a central dividing line.

FIG. 2d shows another embodiment of present invention, where the serration is made up of grooves radiating from the center of the carbide tip.

FIGS. 3a through 3j show different embodiments of present invention, in 2-dimensional display, of how the serration can be formed by grooves of various patterns, including some portion of the carbide tip to remain flat.

FIGS. 4a and 4b show, from profile view of the serration of present invention, that the top of the serration may be angled, in 4a, or rounded-off, in 4b.

### DETAILED DESCRIPTION OF THE PREFERRED EMBODIMENT

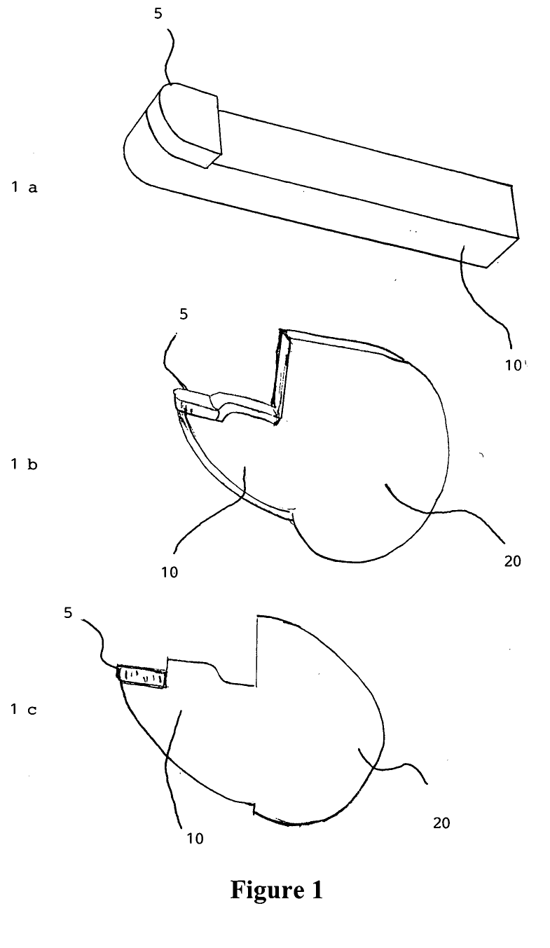

In FIG. 1, carbide tip 5 is attached to the end of the shank portion 10 of a tooth 20 on a cutting disc. FIG. 1a shows the use of a separate shank portion 10. In FIGS. 1b and 1c, shank portion 10 is an integrated part of a tooth 20.

The attachment of a cutting tooth 20 to the disc in a motorized tree stump cutting is not disclosed and is not part of the claimed invention in present application. The means for attaching bottom side of the carbide tip to the shank is not disclosed and is not part of the claimed invention in present application.

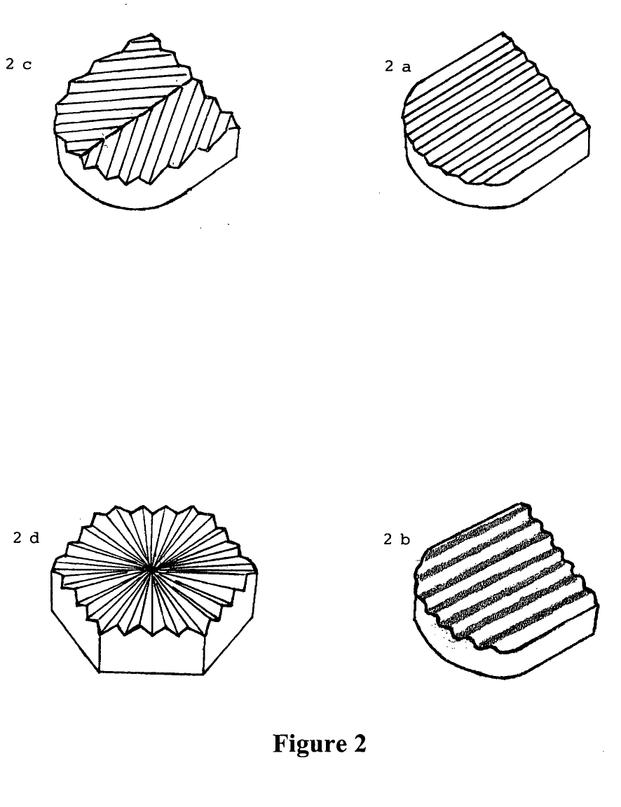

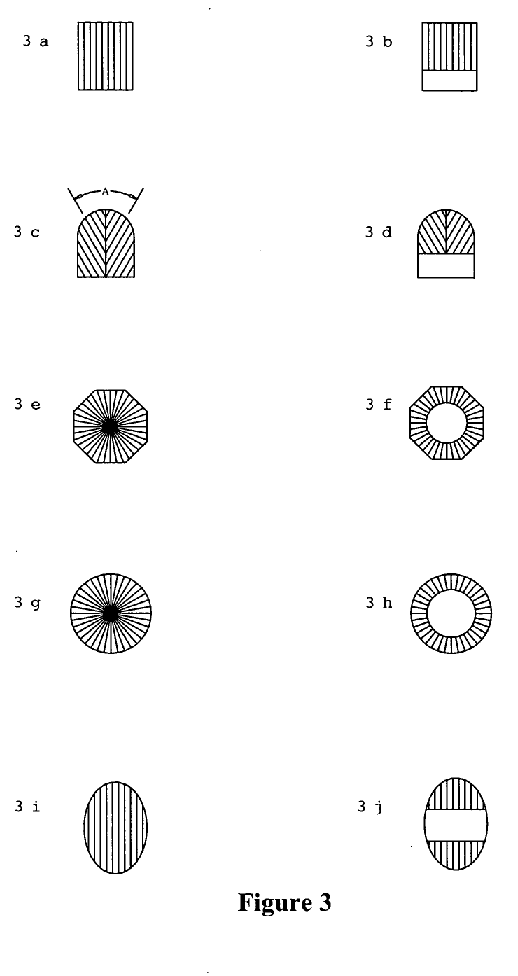

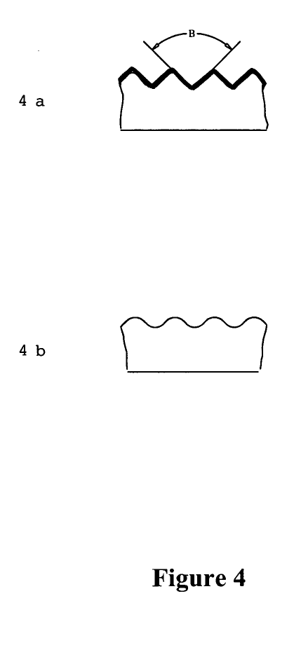

FIGS. 2 and 3 show the embodiment of current invention, whereby the shape of the carbide tip can be a rectangle, a circle, an oval, one side of an elongated oval, a hexagon and/or an octagon.

By adding serration to the cutting surface of a carbide tip, the tree stump cutting disc faces reduced resistance and can deal with varying tree grains, and is more effective when hard rocks or even metals are present when the cutting teeth also have to cut through them.

1. A new type of carbide tip for tree stump grinding and cutting tooth, comprising:
a. An alloy block having a first side for attaching to the shank of a cutting tooth; and
b. Said alloy block having a second side having surface serration forming grooves in different geometric arrangements.

2. The carbide tip of claim 1, wherein said surface serration of second side is made up of parallel grooves.

3. The carbide tip of claim 1, wherein said surface serration of second side is made up of left parallel grooves and right parallel grooves mirroring each other from a central dividing line.

4. The carbide tip of claim 1, wherein said surface serration of second side is made up of grooves radiating out from a central point on said second side.

5. The carbide tip of claim 1, wherein said surface serration of second side contains a partial flat surface.
